(19) United States
(12) Patent Application Publication
(10) Pub. No.: US 2019/0344828 A1
(43) Pub. Date: Nov. 14, 2019

(54) PARKING ASSIST APPARATUS

(71) Applicant: TOYOTA JIDOSHA KABUSHIKI KAISHA, Toyota-shi (JP)

(72) Inventors: Miyuki OMORI, Nagoya-shi (JP); Yasutaka Matsunaga, Nissin-shi (JP); Toshihiro Takagi, Nissin-shi (JP); Satoshi Kozai, Toyota-shi (JP)

(73) Assignee: TOYOTA JIDOSHA KABUSHIKI KAISHA, Toyota-shi (JP)

(21) Appl. No.: 16/402,920

(22) Filed: May 3, 2019

(30) Foreign Application Priority Data
May 8, 2018 (JP) 2018-089984

(51) Int. Cl. B62D 15/02; B60W 50/14

(52) U.S. Cl. CPC B62D 15/0285; B60W 50/082; B60W 2050/146; B60W 50/14

(57) ABSTRACT

A parking assist apparatus executes parking assist control for moving a vehicle along a determined target path to a target region. The parking assist apparatus displays on a display device an image of the vehicle and a vicinity of the vehicle as viewed from a position separated from the vehicle in a direction different from a direction directly above the vehicle at a point in time at which the vehicle is determined to have reached the target region.

### CLAIM OF PRIORITY

The present application claims priority from Japanese patent application JP 2018-089984 filed on May 8, 2018, the content of which is hereby incorporated by reference into this application.

### BACKGROUND

### 1. Technical Field

The present disclosure relates to a parking assist apparatus configured to execute parking assist control for parking a vehicle in a predetermined place.

### 2. Description of the Related Art

Hitherto, there has been proposed a parking assist apparatus in which an overhead view image, which is an image of a vehicle and a peripheral region of the vehicle as viewed from a position above the vehicle, is displayed on a screen of a display during execution of parking assist control.

One related-art parking assist apparatus (third embodiment in Japanese Patent Application Laid-open No. 2007-168560; hereinafter referred to as “related-art apparatus”) superimposes and displays on a screen a first overhead image (reduced image), which is an image obtained by reducing an overhead view image by a magnification set in advance, and a second overhead view image (enlarged image), which is an image obtained by enlarging the overhead view image at a magnification set in advance, and which includes a rear end portion of the vehicle and a separation line in the vicinity of the rear end portion.

A driver may desire to confirm a final parking state of the vehicle (e.g., a positional relationship between the vehicle and a separation line, an object, and the like present in surroundings of the vehicle) when the parking assist control is complete (i.e., a point in time at which the vehicle has reached a target region when parking of the vehicle is complete). However, in the related-art apparatus, no consideration is given to visibility exhibited when the driver confirms the final parking state of the vehicle.

For example, similarly to during execution of the parking assist control, an overhead view image may also be displayed on the screen even when the parking assist control is complete. However, the overhead view image is an image of the vehicle and a peripheral region of the vehicle as viewed from a position directly above the vehicle, and hence the following problems may arise. Specifically, when the vehicle is parked in a parking region separated by separation lines, a part of a separation line and/or a part of an object (e.g., wheel stop) may be hidden under the vehicle body. Therefore, it may be difficult for the driver to accurately grasp the “positional relationship between the vehicle and a separation line, an object, and the like” only from the overhead view image.

### SUMMARY

The present disclosure provides a parking assist apparatus capable of improving visibility exhibited when a driver confirms a final parking state of a vehicle.

A parking assist apparatus according to one embodiment (hereinafter sometimes referred to as “apparatus of one embodiment”) includes: an information acquisition device (81, 82, 83) including at least an image pickup device (83) configured to acquire image data of surroundings of a vehicle, the information acquisition device being configured to acquire vehicle-surroundings information including information on an object present in the surroundings of the vehicle and information on a separation line on a road surface in the surroundings of the vehicle; a path determination module (10, 10X) programmed to determine, based on the vehicle-surroundings information, a target region, which is a region in which the vehicle is to occupy when parking of the vehicle is complete, and determine, as a target path, a path along which the vehicle is movable from a position of the vehicle at a current point in time to the target region; a parking assist module (10, 10Y) programmed to execute parking assist control including steering angle automatic control on the vehicle for moving the vehicle along the determined target path; and a display device (73, 51) configured to display an image to an occupant of the vehicle. The parking assist module is programmed to display on the display device an image (920, 1220, 1310, 1410, 1510, 1720) generated based on the image data acquired by the image pickup device, the image being an image of the vehicle and a vicinity of the vehicle as viewed from a position separated from the vehicle in a direction different from a direction directly above the vehicle at a point in time at which the vehicle is determined to have reached the target region.

The apparatus of one embodiment having such a configuration displays on the display device an image of the vehicle and a peripheral region of the vehicle as viewed from a position different from the position directly above the vehicle at the point in time at which the vehicle is determined to have reached a target region. As a result, the driver can confirm the position of, for example, a separation line and/or an object, which are difficult to grasp in an overhead view image, by looking at the above-mentioned image at and after the point in time at which the parking assist control is complete (i.e., at and after the point in time at which the vehicle is determined to have reached the target region). Therefore, the driver can more accurately grasp the “positional relationship between the vehicle and a separation line, an object, and the like present in the surroundings of the vehicle”.

In one aspect of the apparatus of one embodiment, the display device is configured to display an image including a first display region (301) and a second display region (302). Further, the parking assist module is programmed to: generate, based on the image data acquired by the image pickup device, a first viewpoint image (810, 910, 1110, 1210, 1710) of the vehicle and a vicinity of the vehicle as viewed from a position separated from the vehicle in a direction directly above the vehicle at a point in time at which the vehicle is determined to have reached the target region, and a second viewpoint image (920, 1220, 1310, 1410, 1510, 1720) of the vehicle and a vicinity of the vehicle as viewed from a position separated from the vehicle in a direction different from the direction directly above the vehicle at the point in time at which the vehicle is determined to have reached the target region; and display the first viewpoint image in the first display region and display the second viewpoint image in the second display region.

The parking assist module in this aspect displays the first viewpoint image in the first display region of the screen, and displays the second viewpoint image in the second display region of the screen. The driver can confirm the final parking state of the own vehicle by looking at a plurality of viewpoint images (first viewpoint image and second viewpoint image) of the own vehicle and the peripheral position of the own vehicle as viewed from two different viewpoint positions. Therefore, the driver can more accurately grasp the “positional relationship between the own vehicle and a separation line, an object, and the like”.

In one aspect of the apparatus of one embodiment, the parking assist module is programmed to: generate the first viewpoint image during a period from a point in time at which the parking assist control starts to before the vehicle reaches the target region, and display the first viewpoint image in the first display region at a first display magnification, which allows the entire vehicle and at least a part of the target region to be displayed; and display, at and after a point in time at which the vehicle is determined to have reached the target region, the first viewpoint image in the first display region at a second display magnification, which allows the entire vehicle and at least a part of a peripheral region of the vehicle to be displayed, and which is larger than the first display magnification.

The parking assist module in this aspect displays the first viewpoint image in the first display region at the second display magnification larger than the first display magnification, which is used during execution of parking assist control, at and after the point in time at which the vehicle is determined to have reached the target region. The entire vehicle and a peripheral region of the vehicle are displayed in an enlarged manner in the first display region at and after the point in time at which the vehicle is determined to have reached the target region, and hence visibility exhibited when the driver is performing a final confirmation of the parking state of the vehicle is further improved.

In one aspect of the apparatus of one embodiment, the parking assist module is programmed to: set a plurality of viewpoint positions separated from the vehicle in a plurality of directions different from the direction directly above the vehicle at a point in time at which the vehicle is determined to have reached the target region; generate a plurality of images of the vehicle and a vicinity of the vehicle as viewed from the plurality of viewpoint positions based on the image data acquired by the image pickup device; and serially display the plurality of images on the display device.

The parking assist module in this aspect serially displays in the second display region a plurality of viewpoint images as viewed from the plurality of viewpoint positions different from the viewpoint position that is separated from the vehicle in the direction directly above the vehicle. The driver can confirm the final parking state of the vehicle while looking at the serial display of the plurality of viewpoint images. Therefore, the driver can easily and accurately grasp the “positional relationship between the entire vehicle and a separation line, another vehicle, and the like present in the surroundings of the vehicle”.

Further features relating to the present disclosure become apparent from the description herein and the accompanying drawings. Problems, configurations, and effects other than those described above become apparent from the following description of embodiments of the present disclosure.

In the above description, in order to facilitate understanding of the present disclosure, a name and/or reference numeral used in the embodiments of the present disclosure described later is enclosed in parentheses and assigned to each of the constituent features corresponding to the embodiments. However, each of the constituent features is not limited to the embodiments defined by the name and/or reference numeral.

### BRIEF DESCRIPTION OF THE DRAWINGS

FIG. 1 is a schematic configuration diagram of a parking assist apparatus according to an embodiment.

FIG. 2 is a plan view of a vehicle for illustrating an arrangement of first ultrasonic sensors, second ultrasonic sensors, and cameras.

FIG. 3 is a diagram for illustrating a state in which a screen (display screen) of a touch panel illustrated in FIG. 1 has been divided into three regions.

FIG. 4 is a flowchart for illustrating a “perpendicular parking assist start routine” to be executed by a CPU of a parking assist ECU in the embodiment.

FIG. 5 is a flowchart for illustrating a “parking assist control execution routine” to be executed by the CPU of the parking assist ECU in the embodiment.

FIG. 6 is a flowchart for illustrating a “parking assist control end routine” to be executed by the CPU of the parking assist ECU in the embodiment.

FIG. 7 is a plan view for illustrating a state in which the parking assist ECU in the embodiment has calculated a target path.

FIG. 8 is a diagram for illustrating an image displayed on the touch panel screen during execution of perpendicular parking assist control.

FIG. 9 is a diagram for illustrating an image displayed on the touch panel screen at and after completion of perpendicular parking assist control.

FIG. 10 is a flowchart for illustrating a “parallel parking assist start routine” to be executed by the CPU of the parking assist ECU in the embodiment.

FIG. 11 is a diagram for illustrating an image displayed on the touch panel screen during execution of parallel parking assist control.

FIG. 12 is a diagram for illustrating an image displayed on the touch panel screen at and after completion of parallel parking assist control.

FIG. 13 is a diagram for illustrating a modification example of an image displayed on the touch panel screen at and after completion of perpendicular parking assist control.

FIG. 14 is a diagram for illustrating a modification example of an image displayed on the touch panel screen at and after completion of perpendicular parking assist control.

FIG. 15 is a diagram for illustrating a modification example of an image displayed on the touch panel screen at and after completion of perpendicular parking assist control.

FIG. 16 is a diagram for illustrating a modification example of an image displayed on the touch panel screen at and after completion of perpendicular parking assist control.

FIG. 17 is a diagram for illustrating a modification example of an image displayed on the touch panel screen at and after completion of perpendicular parking assist control.

### DESCRIPTION OF THE EMBODIMENTS

Now, referring to the accompanying drawings, a description is given of one or more embodiments of the present disclosure. The accompanying drawings are illustrations of specific embodiments, but those illustrations are examples to be used for the understanding of the embodiments, and are not to be used to limit the interpretation of the present disclosure.

A parking assist apparatus according to one embodiment (hereinafter sometimes referred to as “apparatus of this embodiment”) is applied to a vehicle. In the following, a vehicle equipped with the parking assist apparatus may be referred to as “own vehicle” in order to distinguish the vehicle from other vehicles.

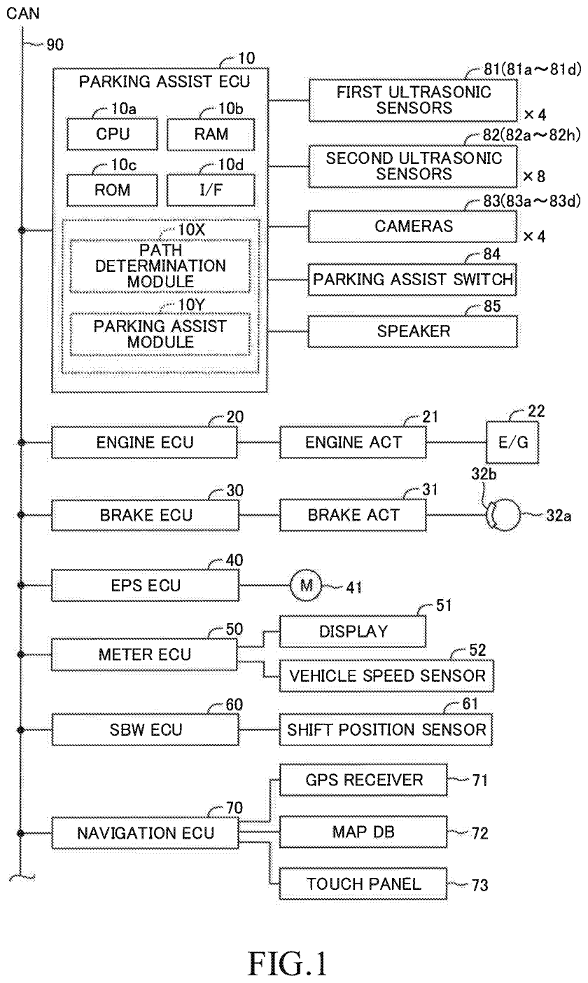

As illustrated in FIG. 1, the parking assist apparatus includes a parking assist ECU 10. The parking assist ECU 10 includes a microcomputer including a central processing unit (CPU) 10a, a random-access memory (RAM) 10b, a read-only memory (ROM) 10c, an interface (I/F) 10d, and other components. The ECU herein stands for “electric control unit”. The ECU includes a microcomputer including a CPU, a RAM, a ROM, an interface, and other components. The CPU is configured to execute instructions stored in the ROM to implement various functions.

The vehicle further includes an engine ECU 20, a brake ECU 30, an electric power steering ECU (hereinafter referred to as “EPS ECU”) 40, a meter ECU 50, a shift-by-wire (SBW) ECU 60, and a navigation ECU 70. The parking assist ECU 10 and those other ECUs are connected to each other such that information can be transmitted and received to and from each other via a controller area network (CAN) 90. Therefore, a detection signal of a sensor connected to a specific ECU is also transmitted to the other ECUs.

The engine ECU 20 is connected to an engine actuator 21. The engine actuator 21 includes a throttle valve actuator configured to change an opening degree of a throttle valve of an internal combustion engine 22. The engine ECU 20 is capable of changing a torque to be generated by the internal combustion engine 22 by driving the engine actuator 21. Thus, the engine ECU 20 is capable of controlling a driving force of the vehicle by controlling the engine actuator 21. When the vehicle is a hybrid vehicle, the engine ECU 20 is capable of controlling a driving force of the vehicle to be generated by any one of or both of “an internal combustion engine and a motor” serving as vehicle driving sources. Further, when the vehicle is an electric vehicle, the engine ECU 20 is capable of controlling a driving force of the vehicle to be generated by a motor serving as a vehicle driving source.

The brake ECU 30 is connected to a brake actuator 31. A braking force (braking torque) to be applied to wheels of the vehicle is controlled by the brake actuator 31. The brake actuator 31 adjusts a hydraulic pressure of liquid to be supplied to wheel cylinders integrated into brake calipers 32b in accordance with an instruction from the brake ECU 30 to use the hydraulic pressure to press brake pads against brake discs 32a, to thereby generate friction braking forces. Thus, the brake ECU 30 is capable of controlling a braking force of the vehicle by controlling the brake actuator 31.

The EPS ECU 40 is connected to an assist motor (M) 41. The assist motor 41 is integrated into a “steering mechanism including a steering wheel, a steering shaft coupled to the steering wheel, and a gear mechanism for steering” (not shown) of the vehicle. The EPS ECU 40 uses a steering torque sensor (not shown) provided in the steering shaft to detect a steering torque input to the steering wheel by the driver, to thereby drive the assist motor 41 based on the steering torque. The EPS ECU 40 applies a steering torque (steering assist torque) to the steering mechanism through the drive of the assist motor 41, to thereby be able to assist the steering operation of the driver.

The meter ECU 50 is connected to a display 51 and a vehicle speed sensor 52. The display 51 is a multi-information display provided in front of a driver's seat. The display 51 displays various types of information in addition to measurement values such as a vehicle speed and an engine revolution speed. A head-up display may be employed as the display 51. The vehicle speed sensor 52 detects the speed of the vehicle (vehicle speed) and outputs a signal indicating the vehicle speed to the meter ECU 50. The vehicle speed detected by the vehicle speed sensor 52 is also transmitted to the parking assist ECU 10.

The SBW ECU 60 is connected to a shift position sensor 61. The shift position sensor 61 detects a position of a shift lever serving as a movable portion of a shift operation portion. In this example, positions of the shift lever include a parking position (P), a drive position (D), and a reverse position (R). The SBW ECU 60 is configured to receive the position of the shift lever from the shift position sensor 61 to control a transmission and/or driving-direction switching mechanism (not shown) of the vehicle based on the shift lever position (i.e., performs shift control of the vehicle). More specifically, when the position of the shift lever is “P”, the SBW ECU 60 controls the transmission and/or driving-direction switching mechanism so that the driving force is not transmitted to drive wheels and the vehicle is thus mechanically locked to a stop position. When the position of the shift lever is “D”, the SBW ECU 60 controls the transmission and/or driving-direction switching mechanism so that the driving force for moving the vehicle forward is transmitted to the drive wheels. Further, when the position of the shift lever is “R”, the SBW ECU 60 controls the transmission and/or driving-direction switching mechanism so that the driving force for moving the vehicle backward is transmitted to the drive wheels. The SBW ECU 60 is configured to output to the steering assist ECU 10 a signal indicating the position of the shift lever received from the shift position sensor 61.

The navigation ECU 70 includes a GPS receiver 71 for receiving a GPS signal for detecting the “latitude and longitude” of the place where the vehicle is positioned, a map database 72 storing map information, and a touch panel (touch panel type display) 73. The navigation ECU 70 performs various arithmetic processing based on the latitude and longitude of the place where the vehicle is positioned, the map information, and the like, and displays on the touch panel 73 the position of the vehicle on the map. The display mode at the time when the “map and position of the vehicle on the map” are displayed on the touch panel 73 is hereinafter referred to as “navigation mode”. The touch panel 73 is a touch panel type display capable of displaying maps, images, and the like. Therefore, for the sake of convenience, the touch panel 73 is also referred to as “display device” or “display”.

The display mode of the touch panel 73 includes, in addition to the navigation mode, a parking assist mode. The parking assist mode is a display mode at the time when parking assist control for parking is performed. A home button (not shown) is arranged near the touch panel 73. In a case where the display mode is the parking assist mode, the display mode switches to the navigation mode when the home button is pressed. In a case where the display mode is the navigation mode, the display mode switches to the parking assist mode when the home button is pressed.

The parking assist ECU 10 is connected to a plurality of first ultrasonic sensors 81a to 81d, a plurality of second ultrasonic sensors 82a to 82h, a plurality of cameras 83a to 83d, a parking assist switch 84, and a speaker 85. The plurality of first ultrasonic sensors 81a to 81d are collectively referred to as “first ultrasonic sensors 81”. The plurality of second ultrasonic sensors 82a to 82d are collectively referred to as “second ultrasonic sensors 82”. The plurality of cameras 83a to 83d are collectively referred to as “cameras 83”.

Each of the first ultrasonic sensors 81 and the second ultrasonic sensors 82 (hereinafter collectively referred to as “ultrasonic sensor” unless it is required to distinguish between the sensors) transmits ultrasonic waves in a pulsed manner in a predetermined range, and receives reflected waves that have been reflected by an object. The ultrasonic sensor is capable of detecting a distance (reflection point distance) between the ultrasonic sensor and a “reflection point, which is a point on the object from which the transmitted ultrasonic waves have been reflected” based on the time from transmission of the ultrasonic waves to reception thereof.

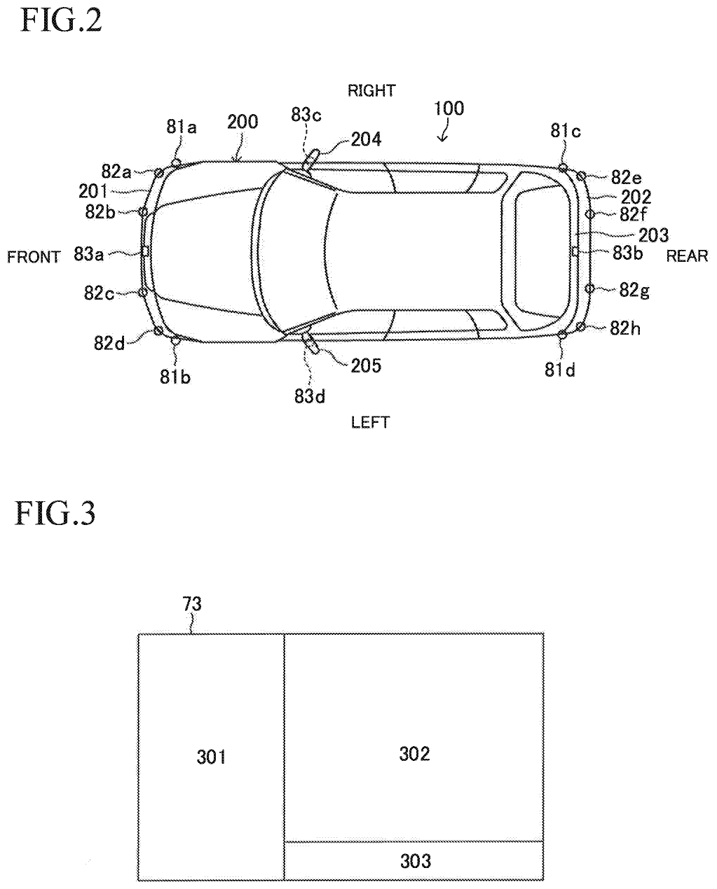

The first ultrasonic sensors 81 are used for detecting objects positioned relatively far from the vehicle compared with the second ultrasonic sensors 82. As illustrated in FIG. 2, the first ultrasonic sensor 81a is arranged at a position on the right side at a front portion of a vehicle body 200 (e.g., a right end portion of a front bumper 201), and detects the reflection point distance of an object on the right side in a front portion of the vehicle. The first ultrasonic sensor 81b is arranged at a position on the left side at the front portion of the vehicle body 200 (e.g., a left side end portion of the front bumper 201), and detects the reflection point distance of an object on the left side in the front portion of the vehicle. The first ultrasonic sensor 81c is arranged at a position on the right side at a rear portion of the vehicle body 200 (e.g., a right side end portion of a rear bumper 202), and detects the reflection point distance of an object on the right side in a rear portion of the vehicle. The first ultrasonic sensor 81d is arranged at a position on the left side at the rear portion of the vehicle body 200 (e.g., a left side end portion of the rear bumper 202), and detects the reflection point distance of an object on the left side in the rear portion of the vehicle.

The second ultrasonic sensors 82 are used for detecting objects relatively close to the vehicle. As illustrated in FIG. 2, four second ultrasonic sensors 82a to 82d are arranged on the front bumper 201 at intervals in a vehicle width direction. The second ultrasonic sensors 82a to 82d detect the reflection point distance of objects in front of the vehicle. Four second ultrasonic sensors 82e to 82h are arranged on the rear bumper 202 at intervals in the vehicle width direction. The second ultrasonic sensors 82e to 82h detect the reflection point distance of objects behind the vehicle.

Each of the cameras 83 is, for example, a digital camera including an image pickup element of a charge coupled device (CCD) or a CMOS image sensor (CIS). The cameras 83 output image data at a predetermined frame rate (i.e., every time a predetermined time elapses). An optical axis of each camera is set obliquely downward from the vehicle body of the vehicle. Therefore, the cameras 83 are configured to photograph a peripheral state (including the position, shape, and the like of the separation lines, objects, parkable regions, and the like) of the vehicle to be confirmed when the vehicle is parked, and output image data to the parking assist ECU 10.

As illustrated in FIG. 2, the camera 83a is arranged at a substantially central portion of the front bumper 201 in the vehicle width direction, and photographs the region in front of the vehicle. The camera 83b is arranged at a wall portion of a rear trunk 203 at the rear portion of the vehicle body 200, and photographs the region behind the vehicle. The camera 83c is arranged on a right-side door mirror 204, and photographs the region to the right side of the vehicle. The camera 83d is arranged on a left-side door mirror 205, and photographs the region to the left of the vehicle. In the following, pieces of image data photographed and obtained by the cameras 83a, 83b, 83c, and 83d may be referred to as “front image data”, “rear image data”, “right side image data”, and “left side image data”, respectively.

The parking assist ECU 10 receives a detection signal from each of the first ultrasonic sensors 81 and the second ultrasonic sensors 82 each time a predetermined period of time (hereinafter also referred to as “first predetermined time” for the sake of convenience) elapses. The parking assist ECU 10 plots information (i.e., reflection points and reflection point distances) included in the detection signals on a two-dimensional map. This two-dimensional map is a plan view in which a vehicle position is set as an origin, a travel direction of the vehicle is set as an X axis, and a left direction of the vehicle is set as a Y axis. The position of the vehicle is the center position in plan view of a left front wheel and a right front wheel. The position of the vehicle may also be another specific position on the vehicle (e.g., a center position of a left rear wheel and a right rear wheel in plan view, position of the center of gravity of the vehicle in plan view, or a geometric center position of the vehicle in plan view).

Each time the first predetermined time elapses, the parking assist ECU 10 acquires image data from each of the cameras 83. The parking assist ECU 10 detects an object in the surroundings of the vehicle by analyzing the image data from each camera 83, and identifies the position (distance and direction) and shape of the object with respect to the vehicle. The parking assist ECU 10 also detects, in the image data from each of the cameras 83, separation lines (including separation lines separating lanes and separation lines separating parking regions) drawn on the road surface in the surroundings of the vehicle, and identifies the position (distance and direction) and shape of the separation lines with respect to the vehicle. The parking assist ECU 10 draws on the above-mentioned two-dimensional map the objects and separation lines that have been specified (detected) based on the image data.

The parking assist ECU 10 detects objects present in the surroundings of the vehicle (within a predetermined distance range from the position of the vehicle) based on the information shown on the two-dimensional map, and also detects a “region in which an object is not present” in the surroundings of the vehicle. When the region in which an object is not present is a region having a size and a shape that allow the own vehicle to park with room to spare, the parking assist ECU 10 determines that region to be a “candidate region”. The candidate region has, for example, a rectangular shape that is not crossed by the detected separation lines, with a long side that is larger than the length in the longitudinal direction of the vehicle by a first margin and a short side that is longer than the length in the lateral direction of the vehicle by a second margin.

The “first ultrasonic sensors 81, second ultrasonic sensors 82, and cameras 83” are collectively referred to as vehicle peripheral sensors (or information acquisition devices). The cameras 83 may also be referred to as an image pickup device configured to acquire image data of the surroundings of the vehicle”. The “information (e.g., position and shape) on an object present in the surroundings of the vehicle and information (e.g., position and shape) on a separation line on the road surface in the surroundings of the vehicle” obtained based on the signals from the vehicle peripheral sensors are also referred to as “vehicle-surroundings information”.

The parking assist switch 84 is a switch to be operated (pressed/depressed) when the driver issues a request for parking assist to the parking assist ECU 10 (when a parking assist request described later is issued). This parking assist control is well-known control for assisting a driving operation by the driver when the driver parks the vehicle. Parking assist control is also called “intelligent parking assist (IPA)”.

The speaker 85 generates a sound when a command to utter a sound is received from the parking assist ECU 10.

(Details of Parking Assist Control)

Each time the parking assist switch 84 is pressed, the parking assist ECU 10 sequentially switches the switch mode from, in order, a perpendicular parking mode, a parallel parking mode, and an unset mode. Therefore, for example, when the parking assist switch 84 is pressed once when the switch mode is the unset mode, the switch mode is changed to the perpendicular parking mode, and when the parking assist switch 84 is pressed twice when the switch mode is the unset mode, the switch mode is changed to the parallel parking mode. When the parking assist switch 84 is pressed twice when the switch mode is the perpendicular parking mode, the switch mode is changed to the unset mode. The parking assist switch 84 may be a rotary type switch, and in this case, the switch mode is switched to the perpendicular parking mode, the parallel parking mode, and the unset mode in accordance with a position to which the parking assist switch 84 is rotated.

The perpendicular parking mode is a mode in which parking assist is performed when the own vehicle is parked in a direction perpendicular to the travel direction of a road being traveled along. Perpendicular parking is synonymous with moving the own vehicle to park the own vehicle in parallel to other parked vehicles. More specifically, perpendicular parking refers to parking the own vehicle such that one side of the own vehicle is opposed to one side of another vehicle (first another vehicle) and the other side of the own vehicle is opposed to one side of another vehicle (second another vehicle), and a longitudinal direction axis passing through the center of the own vehicle in the vehicle width direction and a longitudinal direction axis passing through the center of each of the first and second another vehicles in the vehicle width direction are parallel to each other. Perpendicular parking includes parking the own vehicle such that the own vehicle faces in a right-angle direction to the travel direction of the road being traveled along and at least one of the left and right sides of the own vehicle is parallel to “a white line, a wall, a fence, a guardrail, or the like”.

The parallel parking mode is the mode in which parking assist is performed when the own vehicle is parked in a direction parallel to the travel direction of the road being traveled along. Parallel parking is synonymous with parking the own vehicle to come into line with other vehicles parked along the travel direction of the road. More specifically, in parallel parking, the own vehicle is parked such that the front end portion of the own vehicle is opposed to the rear end portion (or front end portion) of the first another vehicle and the rear end portion of the own vehicle is opposed to the front end portion (or rear end portion) of the second another vehicle, and the longitudinal direction axis passing through the center of the own vehicle in the vehicle width direction and the longitudinal direction axis passing through the center of each of the first and second another vehicles in the vehicle width direction are positioned on substantially the same line.

As described later, the parking assist ECU 10 monitors operations performed on the parking assist switch 84, the position of the shift lever, and the state of the own vehicle to determine whether or not a parking assist request has been issued. Examples of the parking assist request include a perpendicular parking assist request and a parallel parking assist request.

«Perpendicular Parking Assist Request»

The parking assist ECU 10 determines that a perpendicular parking assist request has been issued when all the conditions described below are satisfied.
(Condition A1) Neither a perpendicular parking assist request nor a parallel parking assist request has been issued.
(Condition A2) The perpendicular parking mode has been selected by a predetermined operation on the parking assist switch 84 (e.g., pressed once).
(Condition A3) The position of the shift lever at the time when the condition A2 is satisfied is the drive position (D).
(Condition A4) At the time when the condition A2 is satisfied, the driver has operated a brake pedal to stop the own vehicle (i.e., the speed is 0 [km/h]).
(Condition A5) A candidate region (perpendicular parking candidate region) that is adjacent to the road being traveled along, has a shortest distance from the position of the own vehicle equal to or less than a predetermined distance, and has a size and shape allowing the own vehicle to be parked through the perpendicular parking mode has been detected.

The condition A4 may be a condition that the vehicle speed is equal to or lower than a predetermined low speed threshold value (e.g., 30 [km/h]).

«Parallel Parking Assist Request»

The parking assist ECU 10 determines that a parallel parking assist request has been issued when all the conditions described below are satisfied.
(Condition B1) Neither a perpendicular parking assist request nor a parallel parking assist request has been issued.
(Condition B2) The parallel parking mode has been selected by a predetermined operation on the parking assist switch 84 (e.g., pressed twice consecutively).
(Condition B3) The position of the shift lever at the time when the condition B2 is satisfied is the drive position (D).
(Condition B4) At the time when the condition B2 is satisfied, the driver has operated the brake pedal to stop the own vehicle (i.e., the vehicle speed is 0 [km/h]).
(Condition B5) A candidate region (parallel parking candidate region) that is adjacent to the road being traveled along, has a shortest distance from the position of the own vehicle equal to or less than a predetermined distance, and has a size and shape allowing the own vehicle to be parked through the parallel parking mode has been detected.

The condition B4 may be a condition that the vehicle speed is equal to or lower than a predetermined low speed threshold value (e.g., 30 [km/h]).

When a perpendicular parking assist request has been issued, the parking assist ECU 10 executes parking assist control for causing the own vehicle to park itself in a predetermined region (target region to be described later) within the perpendicular parking candidate region.

When a parallel parking assist request has been issued, the parking assist ECU 10 executes parking assist control for causing the own vehicle to park itself in a predetermined region (target region) within the parallel parking candidate region.

When it is determined that the above-mentioned parking assist request has been issued, the parking assist ECU 10 sets the position of the own vehicle at the time when the own vehicle is assumed to be parked in the candidate region (e.g., a center position in plan view of the left front wheel and the right front wheel of the own vehicle) as the target position. The parking assist ECU 10 determines/sets, as a target path, a path along which the position of the own vehicle is to be moved from the current own vehicle position (current position) to the target position. The parking assist ECU 10 executes parking assist control such that the vehicle moves along the target path.

The parking assist ECU 10 is configured to execute shift control, steering angle automatic control, driving force control, and braking force control as parking assist control. Therefore, when the target path has been determined, the parking assist ECU 10 determines “the direction to move the own vehicle (specifically, the position of the shift lever), a steering angle pattern, and a speed pattern” for moving the own vehicle along the target path.

The parking assist ECU 10 transmits a shift control command to the SBW ECU 60 via the CAN 90 in accordance with the determined position of the shift lever. When a shift control command has been received from the parking assist ECU 10, the SBW ECU 60 changes the position of the shift lever to the position specified by the shift control command (i.e., executes shift control).

The steering angle pattern is data in which the position of the own vehicle on the target path and the steering angle are associated with each other. The parking assist ECU 10 transmits a steering command (including a target steering angle) to the EPS ECU 40 via the CAN 90 in accordance with the determined steering angle pattern. When the steering command has been received from the parking assist ECU 10, the EPS ECU 40 drives the assist motor 41 based on the steering torque specified by the steering command to cause the actual steering angle to match the target steering angle (i.e., executes steering angle automatic control).

The speed pattern is data in which the position of the own vehicle on the target path and a travel speed of the own vehicle are associated with each other. The speed pattern represents changes in the travel speed exhibited when the vehicle travels along the target path. The parking assist ECU 10 transmits a driving force control command to the engine ECU 20 via the CAN 90 in accordance with the determined speed pattern. When the driving force control command has been received from the parking assist ECU 10, the engine ECU 20 controls the engine actuator 21 in accordance with the driving force control command (i.e., executes driving force control). The parking assist ECU 10 also transmits a braking force control command to the brake ECU 30 via the CAN 90 in accordance with the determined speed pattern. When the braking force control command has been received from the parking assist ECU 10, the brake ECU 30 controls the brake actuator 31 in accordance with the braking force control command (i.e., executes braking force control).

As described above, the parking assist ECU 10 has functions as a “path determination module 10X” programmed to determine a target path” and as a “parking assist module 10Y programmed to execute parking assist control”, which are implemented by the CPU 10a.

(Screen Display)

Next, the screen of the touch panel 73 (hereinafter simply referred to as “screen”) at the time when the display mode is the parking assist mode is described. As illustrated in FIG. 3, the screen has a first display region 301, a second display region 302, and a third display region 303. The first display region 301 is a region on the left side obtained when the screen is divided into two regions of left and right regions, and has a vertically elongated rectangular shape. The second display region 302 is a part of the region on the right side obtained when the screen is divided into two regions of left and right regions as described above, and is a region on the upper side obtained when the region on the right side is divided into two regions of upper and lower regions. The second display region 302 has a horizontally elongated rectangular shape. The third display region 303 is a region on the lower side obtained when the above-mentioned region on the right side is divided into two regions of upper and lower regions, and has a horizontally elongated rectangular shape. The size of each of the first display region 301 to the third display region 303 is a fixed predetermined size. The first display region 301 to the third display region 303 are divided such that the area of the second display region 302 is the largest and the area of the third display region 303 is the smallest.

(Image Generation)

When the display mode is the parking assist mode, the parking assist ECU 10 displays a “travel direction image and viewpoint image”, which are described below, on the screen. In the following, a method of generating each of the travel direction image and the viewpoint image is briefly described.

The parking assist ECU 10 generates a travel direction image displaying the region of the travel direction of the own vehicle based on the front image data and the rear image data. While the own vehicle is traveling in reverse (i.e., the position of the shift lever detected by the shift position sensor 61 is “R”), the parking assist ECU 10 generates a travel direction image for showing the region behind the own vehicle based on the rear image data. Meanwhile, when the own vehicle is traveling in the forward direction (i.e., when the position of the shift lever detected by the shift position sensor 61 is “D”), the parking assist ECU 10 generates a travel direction image for showing the region in front of the own vehicle based on the front image data.

The parking assist ECU 10 also generates, based on the front image data, the rear image data, the right side image data, and the left side image data, an image of the own vehicle and the peripheral region of the own vehicle as viewed from a set viewpoint position (hereinafter referred to as “viewpoint image”). A method of generating such a viewpoint image is well known (see, for example, Japanese Patent Application Laid-open No. 2012-217000 and Japanese Patent Application Laid-open No. 2013-021468). Therefore, an example of the method of generating a viewpoint image is briefly described below.

The parking assist ECU 10 generates three-dimensional data on the peripheral region of the own vehicle by combining at least the “image data acquired from each of the cameras 83 each time the first predetermined time elapses during the period from the start time point of parking assist control to the completion time point thereof”. The three-dimensional data includes data on “separation lines and objects (e.g., wheel stop)” and the like positioned under the own vehicle at the time when the own vehicle reaches the target position. In other words, the generated three-dimensional data includes data on “objects and/or separation lines” or the like that is not included in the image data acquired from each of the cameras 83 at the time when the own vehicle reaches the target position.

The parking assist ECU 10 projects the three-dimensional data generated in the manner described above onto a three-dimensional curved surface in a virtual three-dimensional space covering the own vehicle. The three-dimensional curved surface has a substantially hemispherical shape, for example. The relationship between the coordinates of the three-dimensional data and the coordinates of the three-dimensional curved surface is defined in advance. The own vehicle is arranged at the center part (bottom part of the hemisphere) of the three-dimensional curved surface. The own vehicle in the three-dimensional curved surface is generated as a polygon model representing a three-dimensional shape based on data, for example, the shape and size of the vehicle body stored in the ROM 10c in advance.

The parking assist ECU 10 sets virtual viewpoints (first virtual viewpoint and second virtual viewpoint described later) in the virtual three-dimensional space. Each of the virtual viewpoints is defined by a viewpoint position and a viewing direction. The parking assist ECU 10 extracts images based on the set virtual viewpoints from the virtual three-dimensional space.

More specifically, the parking assist ECU 10 generates a “first viewpoint image, which is an image of the own vehicle and the peripheral region of the own vehicle based on a first virtual viewpoint” during the period from the point in time at which parking assist control starts to before the own vehicle reaches the target region. When the own vehicle is determined to have reached the target position, the parking assist ECU 10 further generates the “first viewpoint image, which is an image of the own vehicle and the peripheral region of the own vehicle based on the first virtual viewpoint” and a “second viewpoint image, which is an image of the own vehicle and the peripheral region of the own vehicle based on a second virtual viewpoint different from the first virtual viewpoint”.

The viewpoint position of the first virtual viewpoint (hereinafter sometimes referred to as “first viewpoint position”) is a position separated from the center position in plan view of the vehicle body of the own vehicle by a predetermined first distance in a directly upward direction. The viewing direction of the first virtual viewpoint is a directly downward direction from the first viewpoint position toward the own vehicle. Therefore, the first viewpoint image is an image looking down on the own vehicle from a position directly above the own vehicle. Such a viewpoint image is also referred to as “overhead view image”.

The viewpoint position of the second virtual viewpoint (hereinafter sometimes referred to as “second viewpoint position”) is a position separated from the own vehicle in a direction different from the direction directly above the own vehicle. In this example, the viewpoint position of the second virtual viewpoint is a position separated from the center position in the vehicle width direction of the front end portion of the vehicle body of the own vehicle by a predetermined second distance in front of the own vehicle. The viewing direction of the second virtual viewpoint is the direction from the second viewpoint position toward the own vehicle. Therefore, the second viewpoint image is an image as if the own vehicle is viewed from the front. Such a viewpoint image is also referred to as “front image”.

As described above, the parking assist ECU 10 is capable of generating viewpoint images for showing how the own vehicle and the peripheral region of the own vehicle look from set virtual viewpoints.

(Outline of Operation)

There may be cases in which the driver desires to confirm the final parking state of the own vehicle (e.g., positional relationship between the own vehicle and a separation line, an object, and the like present in the surroundings of the own vehicle) even after the time at which parking assist control is complete (i.e., time at which the own vehicle reaches the target region). However, when the own vehicle is parked in a parking region separated by separation lines, a part of the separation lines and/or a part of an object (e.g., wheel stop) may be hidden under the vehicle body. Under such circumstances, it is difficult for the driver to accurately grasp the “positional relationship between the own vehicle and a separation line, an object, and the like” based only on the overhead view image, which is an image of the own vehicle and the peripheral region of the own vehicle as viewed from a position directly above the own vehicle.

In consideration of this, the apparatus of this embodiment displays on the screen an image (second viewpoint image) of the own vehicle and the vicinity of the own vehicle as viewed from a position (second viewpoint position) separated from the own vehicle in a direction different from the direction directly above the own vehicle at the point in time at which the vehicle is determined to have reached the target region. In the example described below, the second viewpoint image is a front image. The apparatus of this embodiment may also display on the screen buttons for changing the position of the second virtual viewpoint. The driver can change the position of the second virtual viewpoint by operating the buttons on the screen. With the above-mentioned configuration, the driver can confirm the position of separation lines and/or objects and the like that are difficult to grasp in an overhead view image (first viewpoint image) by looking at the second viewpoint image. Therefore, the driver can more accurately grasp the “positional relationship between the vehicle and a separation line, an object, and the like present in the surroundings of the vehicle”.

The apparatus of this embodiment also displays a plurality of viewpoint images on the screen at and after the point in time at which the own vehicle is determined to have reached the target position. Specifically, the apparatus of this embodiment displays in the first display region 301 a first viewpoint image (overhead view image), which is an image of the own vehicle and the peripheral region of the own vehicle based on the above-mentioned first virtual viewpoint. The apparatus of this embodiment also displays in the second display region 302 an image (second viewpoint image) of the own vehicle and the peripheral region of the own vehicle based on the second virtual viewpoint different from the first virtual viewpoint. With this configuration, the driver can confirm the final parking state of the own vehicle based on a plurality of different viewpoint positions. Therefore, the driver can more accurately grasp the “positional relationship between the own vehicle and a separation line, an object, and the like”.

The apparatus of this embodiment also generates a first viewpoint image (overhead view image) during the period from the point in time at which parking assist control starts to before the own vehicle reaches the target region, and displays the first viewpoint image in the first display region 301 at a first display magnification, which allows the entire own vehicle and at least a part of the target region to be displayed. The apparatus of this embodiment also displays, at and after the point in time at which the own vehicle is determined to have reached the target region, in the first display region 301 the first viewpoint image (overhead view image) at a second display magnification, which allows the entire own vehicle and at least a peripheral region of the own vehicle to be displayed, and which has a larger magnification than the first display magnification. With this configuration, at and after the point in time at which the own vehicle is determined to have reached the target region, the “size of the own vehicle and size of a separation line, an object, and the like” are increased on the screen. Therefore, visibility exhibited when the driver confirms the “positional relationship between the own vehicle and a separation line, an object, and the like” is improved.

(Operations in Perpendicular Parking Assist)

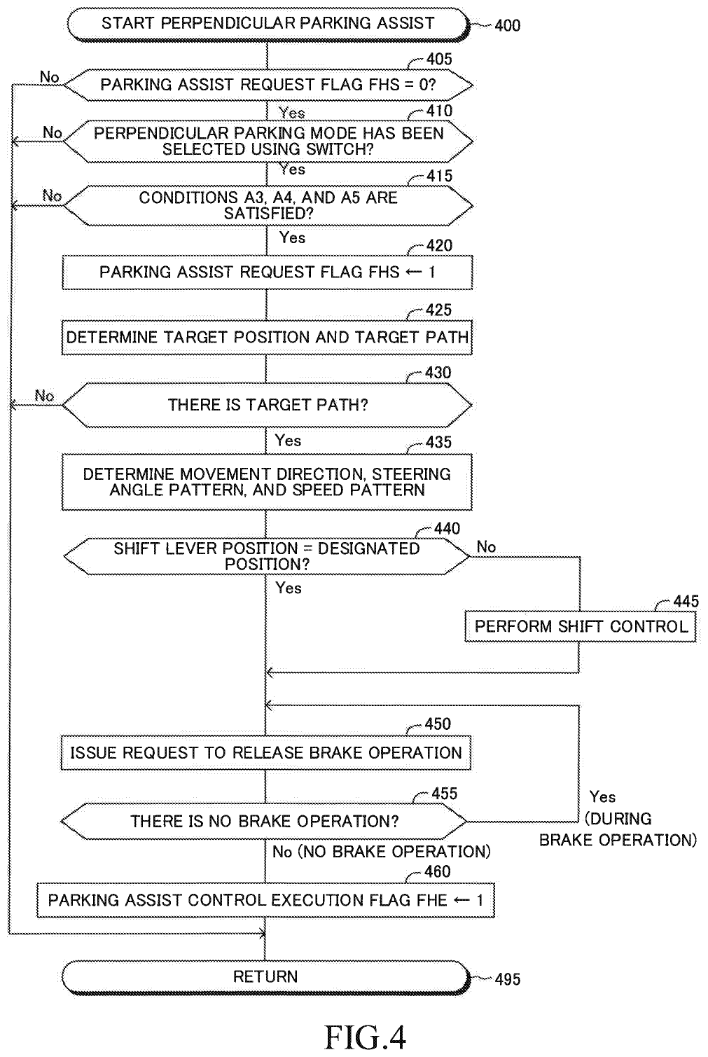

Next, operations to be performed when parking assist control is executed in response to a perpendicular parking assist request are described. The CPU 10a of the parking assist ECU 10 (hereinafter simply referred to as “CPU”) is configured to execute each of the routines illustrated in FIG. 4 to FIG. 6 each time a “second predetermined time longer than the first predetermined time” elapses. The CPU further acquires the vehicle-surroundings information from the vehicle peripheral sensors by executing a routine (not shown) each time the first predetermined time elapses. The CPU also updates the above-mentioned two-dimensional map based on the vehicle-surroundings information by executing a routine (not shown) each time the first predetermined time elapses.

In addition, when an ignition key switch (start switch) (not shown) of the vehicle is changed from an off position to an on position, the CPU executes an initialization routine (not shown) to set values of various flags, which are described later, to “0”.

When a predetermined timing is reached, the CPU starts the processing from Step 400 of FIG. 4, and advances the processing to Step 405. In Step 405, the CPU determines whether or not a value of a parking assist request flag (hereinafter simply referred to as “request flag”) FHS is “0”. When the value of the request flag FHS is “0”, this means that a parking assist request (any one of the perpendicular parking assist request and the parallel parking assist request) has not been issued. When the value of the request flag FHS is “1”, this means that a parking assist request has been issued. Therefore, in Step 405, the CPU determines whether or not the condition A1 is satisfied. When the value of the request flag FHS is not “0”, the CPU makes a determination of “No” in Step 405, advances the processing directly to Step 495, and temporarily ends this routine.

Assuming that the value of the request flag FHS is “0”, the CPU makes a determination of “Yes” in Step 405, and advances the processing to Step 410. In Step 410, the CPU determines whether or not the perpendicular parking mode has been selected by a predetermined operation of the parking assist switch 84 (whether or not the condition A2 is satisfied). When it is determined that the perpendicular parking mode is not selected, the CPU makes a determination of “No” in Step 410, advances the processing directly to Step 495, and temporarily ends this routine.

Assuming that the perpendicular parking mode has been selected, the CPU makes a determination of “Yes” in Step 410, and advances the processing to Step 415. In Step 415, the CPU determines whether or not all of the above-mentioned “condition A3, condition A4, and condition A5” are satisfied. The condition that all of the conditions A3, A4, and A5 are satisfied is also referred to as “perpendicular parking assist execution condition”. When the perpendicular parking assist execution condition is not satisfied, the CPU makes a determination of “No” in Step 415, advances the processing directly to Step 495, and temporarily ends this routine.

Assuming that the perpendicular parking assist execution condition is satisfied, the CPU makes a determination of “Yes” in Step 415, performs the processing of Step 420 and Step 425 (described below) in order, and advances the processing to Step 430.

Step 420: The CPU sets the value of the request flag FHS to “1”.

Step 425: The CPU sets, as a provisional target region, a region occupied by the vehicle body of the own vehicle when it is assumed that the own vehicle has been parked in each of the detected perpendicular parking candidate regions. The CPU also sets, as a provisional target position, the position of the own vehicle at the time when the own vehicle has been parked in that provisional target region.

In Step 425, the CPU also calculates a path along which the position of the own vehicle is to be moved from the current own vehicle position (current position) to the provisional target region as a provisional target path. The target path is a path along which the vehicle body of the own vehicle can be moved from its current position to the target position while maintaining a gap equal to or more than a predetermined distance from an object (e.g., another vehicle, a curb stone, and a guardrail). Therefore, the CPU determines, as the provisional target path, a path that allows the own vehicle to move to the provisional target region “while maintaining the distance between the own vehicle and the object at a predetermined distance (margin distance) or more”. Therefore, in some situations, it may not be possible to calculate a provisional target path (provisional target path does not exist). The target path may also be calculated by one of various known calculation methods (e.g., a method proposed in Japanese Patent Application Laid-open No. 2015-3565). After that, the CPU determines a target path having the shortest distance among the provisional target paths as the final target path.

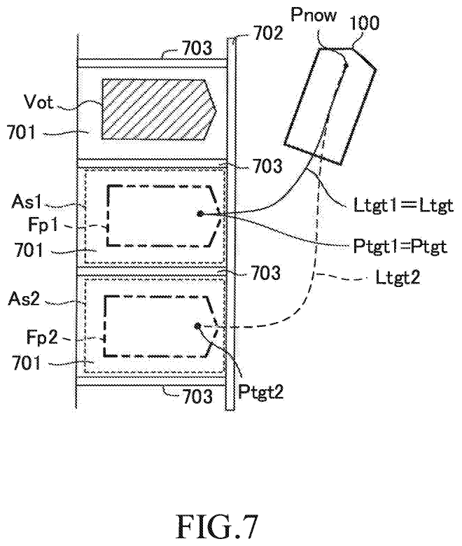

For example, in the example illustrated in FIG. 7, there are a plurality of parking regions 701 in the vicinity of an own vehicle 100, which is positioned at a current position Pnow. The plurality of parking regions 701 are separated by a first separation line 702 and a plurality of second separation lines 703. The CPU has detected another vehicle Vot as an object. Therefore, the CPU recognizes that there are a perpendicular parking candidate region As1 and a perpendicular parking candidate region As2 in the vicinity of the own vehicle 100.

In this situation, when the CPU advances to Step 425 of the routine illustrated in FIG. 4, the CPU sets a provisional target region Fp1 for the perpendicular parking candidate region As1, and determines, as a provisional target position Ptgt1, a position of the own vehicle 100 at the time when it is assumed that the own vehicle 100 has been parked in the provisional target region Fp1. Then, the CPU calculates, as a provisional target path Ltgt1, a path for moving the position of the own vehicle 100 from the current position Pnow of the own vehicle 100 to the provisional target position Ptgt1. Similarly, the CPU sets a provisional target region Fp2 for the perpendicular parking candidate region As2, and determines, as a provisional target position Ptgt2, a position of the own vehicle 100 at the time when it is assumed that the own vehicle 100 has been parked in the provisional target region Fp2. Then, the CPU calculates, as a provisional target path Ltgt2, a path for moving the position of the own vehicle 100 from the current position Pnow of the own vehicle 100 to the provisional target position Ptgt2. After that, the CPU determines the target path Ltgt1, which has the shortest distance of the provisional target paths (Ltgt1 and Ltgt2), as a final target path Ltgt. Therefore, the perpendicular parking candidate region As1 is determined as the final perpendicular parking region, the provisional target region Fp1 is determined as the final target region, and the provisional target position Ptgt1 is determined as the final target position Ptgt.

Next, the CPU advances the processing to Step 430 of the routine illustrated in FIG. 4, and determines whether or not there is a final target path (whether or not a final target path has successfully been calculated). When there is no final target path, the CPU makes a determination of “No” in Step 430, advances the processing directly to Step 495, and temporarily ends this routine. In this case, the CPU may display a message “Please move vehicle to another place” on the screen, and then return to Step 425. The CPU may also cause the speaker 85 to utter the message displayed on the screen.

On the other hand, when there is a final target path, the CPU makes a determination of “Yes” in Step 430, and advances the processing to Step 435. In Step 435, the CPU determines “the direction to move the own vehicle (specifically, the position of the shift lever), the steering angle pattern, and the speed pattern for moving the own vehicle” for moving the own vehicle along the final target path Ltgt.

Next, in Step 440, the CPU determines whether or not the current shift lever position matches the “position designated in Step 435”. When the current shift lever position matches the designated position, the CPU makes a “Yes” determination in Step 440, and advances the processing to Step 450. In Step 450, the CPU issues to the driver a request to release the operation of the brake pedal. Specifically, the CPU displays a message “Please remove your foot from the brake pedal” on the screen, and causes the speaker 85 to utter that message.

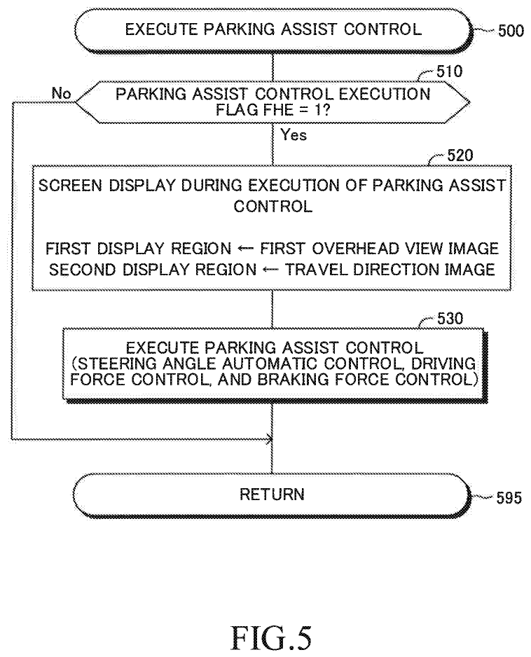

Next, in Step 455, the CPU determines whether or not the driver is operating the brake pedal. When the driver is not operating the brake pedal (the driver has removed the foot from the brake pedal), the CPU makes a determination of “No” in Step 455, and advances the processing to Step 460. In Step 460, the CPU sets a value of a parking assist control execution flag (hereinafter simply referred to as “execution flag”) FHE to “1”. Then, the CPU advances the processing to Step 495, and temporarily ends this routine. As a result, parking assist control is started (see determination of “Yes” in Step 510 of the routine of FIG. 5, which is described later). On the other hand, when the driver is still operating the brake pedal at the point in time at which the CPU advances to Step 455, the CPU returns the processing to Step 450.

On the other hand, when the shift lever position does not match the “position designated in Step 435” at the point in time at which the CPU advances to Step 440, the CPU makes a determination of “No” in Step 440, and advances the processing to Step 445. In Step 445, the CPU transmits a shift control command to the SBW ECU 60 in accordance with the designated shift lever position. The SBW ECU 60 changes the shift lever position to the position specified by the shift control command. Then, the CPU performs the processing of Step 450 to Step 460 in order as described above. Then, the CPU advances the processing to Step 495, and temporarily ends this routine.

When a predetermined timing is reached, the CPU starts the processing from Step 500 of FIG. 5, and advances the processing to Step 510. In Step 510, the CPU determines whether or not a value of the execution flag FHE is “1”. When the value of the execution flag FHE is not “1”, the CPU makes a determination of “No” in Step 510, advances the processing directly to Step 595, and temporarily ends this routine.

On the other hand, when the value of the execution flag FHE is “1”, the CPU makes a determination of “Yes” in Step 510, and performs in order the processing of Step 520 and Step 530 described below. Then, the CPU advances the processing to Step 595 and temporarily ends this routine.

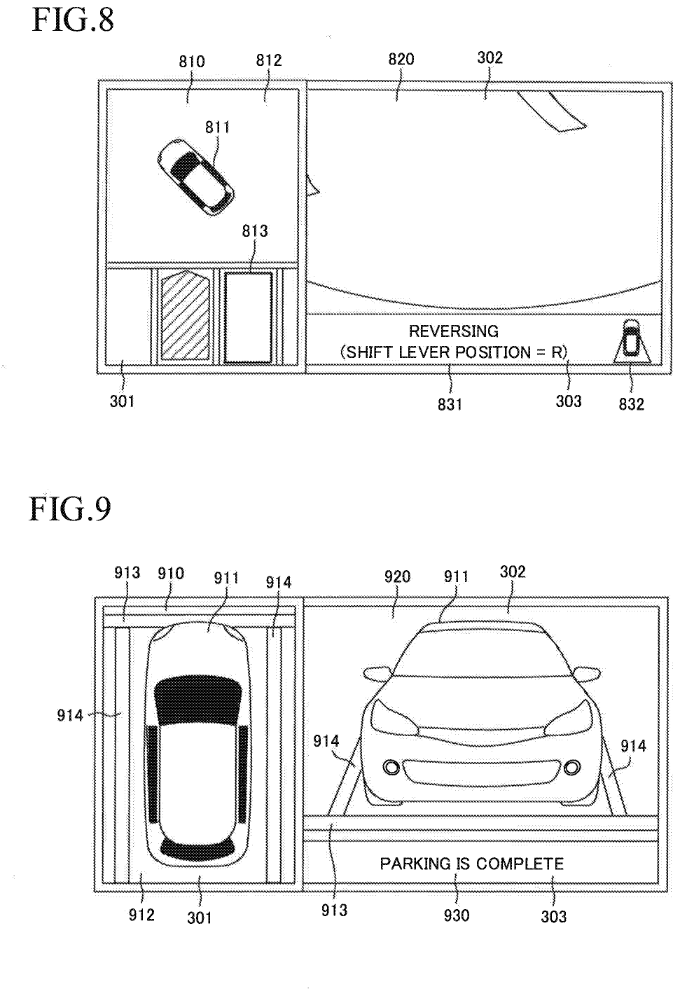

Step 520: The CPU automatically changes the display mode of the touch panel 73 to the parking assist mode. As illustrated in FIG. 8, the CPU generates a first overhead view image 810 based on the front image data, the rear image data, the right side image data, and the left side image data, and displays the first overhead view image 810 at the first display magnification in the first display region 301.

The first overhead view image 810 is an image of the own vehicle and the peripheral region of the own vehicle based on the above-mentioned first virtual viewpoint. Therefore, the first overhead view image 810 corresponds to an example of the “first viewpoint image”. The viewpoint position of the first virtual viewpoint is a position (first viewpoint position) separated from the center position in plan view of the vehicle body by a predetermined first distance in the directly upward direction. The viewing direction of the first virtual viewpoint is the direction from the first viewpoint position directly down toward the own vehicle. The first viewpoint position is set to a position sufficiently separated upward from the own vehicle such that the entire own vehicle and the target region are included in the viewpoint image (first overhead view image 810).

The CPU sets the first display magnification to a magnification that allows the entire own vehicle 811 and at least a part of a target region 813 to be displayed. Therefore, the first overhead view image 810 includes the entire own vehicle 811 and a peripheral region 812 thereof. The peripheral region 812 includes the separation lines and objects present in the surroundings of the own vehicle 811, and the target region 813 corresponding to the target position.

As illustrated in FIG. 8, the CPU displays a travel direction image 820 in the second display region 302. The travel direction image 820 is an image from the camera corresponding to the travel direction of the own vehicle. The own vehicle is moving reverse at the moment, and hence the travel direction image 820 is the rear image data acquired by the camera 83b.

The CPU also displays a travel direction message 831 and a vehicle mark 832 in the third display region 303. The travel direction message 831 is a message including the direction the own vehicle is to travel (i.e., the position of the shift lever). The vehicle mark 832 is a mark indicating in which direction of the forward direction or the reverse direction of the own vehicle the travel direction image 820 is shown.

Step 530: The CPU executes parking assist control. Specifically, the CPU executes steering angle automatic control by transmitting a steering command (target steering angle) to the EPS ECU 40 in accordance with the steering angle pattern. The CPU also executes driving force control by transmitting a driving force control command to the engine ECU 20 in accordance with the speed pattern. The CPU also executes braking force control by transmitting a braking force control command to the brake ECU 30 in accordance with the speed pattern. As a result, the driver can move the own vehicle to the target region (move the position of the own vehicle to the target position) without operating the steering wheel, the accelerator pedal, or the brake pedal by himself or herself. When the driver requests a large braking force by operating the brake pedal at a point in time at which Step 520 is being executed, the brake actuator 31 is controlled such that a braking force corresponding to that request is generated. In that case, the driving force of the vehicle is set to “0” by controlling the engine actuator 21.

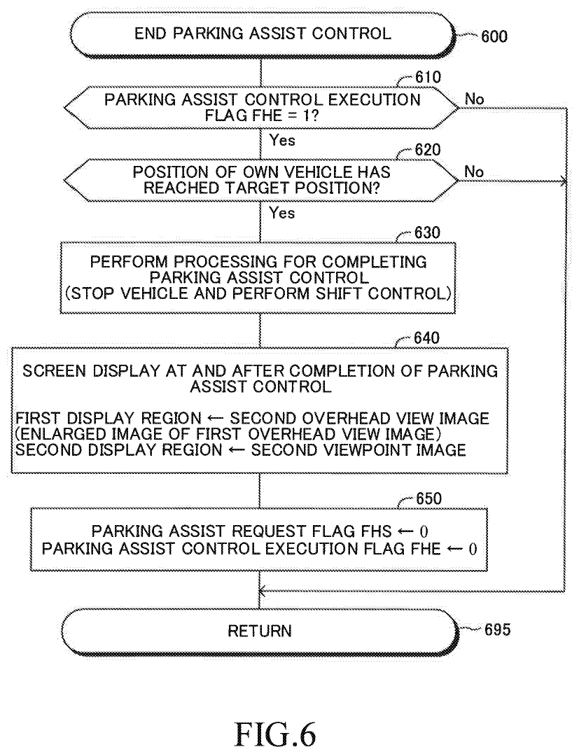

When a predetermined timing is reached, the CPU starts the processing from Step 600 of FIG. 6, and advances the processing to Step 610. In Step 610, the CPU determines whether or not the value of the execution flag FHE is “1”. When the value of the execution flag FHE is not “1”, the CPU makes a determination of “No” in Step 610, advances the processing directly to Step 695, and temporarily ends this routine.

When the value of the execution flag FHE is “1”, the CPU makes a determination of “Yes” in Step 610, and advances the processing to Step 620. In Step 620, the CPU determines whether or not the position of the own vehicle has reached the final target position (whether or not the own vehicle has reached the final target region). When the position of the own vehicle has not reached the target position, the CPU makes a determination of “No” in Step 620, advances the processing directly to Step 695, and temporarily ends this routine.

On the other hand, when the position of the own vehicle has reached the target position, the CPU makes a determination of “Yes” in Step 620, and performs the processing of Step 630 to Step 650 (described below) in order. Then, the CPU advances the processing to Step 695, and temporarily ends this routine.

Step 630: The CPU performs processing for completing the parking assist control. Specifically, the CPU transmits a braking force control command to the brake ECU 30 to generate a braking force and stop the own vehicle. The CPU also transmits the shift control command to the SBW ECU 60 to change the position of the shift lever to a parking position (P).

Step 640: As illustrated in FIG. 9, the CPU displays a second overhead view image 910 in the first display area 301. The second overhead view image 910 corresponds to an example of the “first viewpoint image”. In this example, the second overhead view image 910 is an enlarged image of the first overhead view image 810. More specifically, the CPU displays the first overhead view image 810 in the first display region 301 at a second display magnification larger than the first display magnification.

When there are separation lines separating the perpendicular parking region, the CPU sets the second display magnification to a magnification that allows display of the entire own vehicle 911 and separation lines (first separation line 913 and second separation lines 914) separating a perpendicular parking region in which the own vehicle 911 is parked. Therefore, the second overhead view image 910 includes the entire own vehicle 911 and a peripheral region 912 of the own vehicle 911. The peripheral region 912 includes the first separation line 913 and the second separation lines 914 on the left and right sides of the own vehicle 911.

The CPU generates a second viewpoint image 920 based on the front image data, the rear image data, the right side image data, and the left side image data, and displays the second viewpoint image 920 in the second display region 302. The second viewpoint image 920 is an image (front image) of the own vehicle and the peripheral region of the own vehicle based on the above-mentioned second virtual viewpoint. The viewpoint position of the second virtual viewpoint is a position (second viewpoint position) separated from the center position in the vehicle width direction of the front end portion of the vehicle body toward the front of the own vehicle by a predetermined second distance. The viewing direction of the second virtual viewpoint is the direction from the second viewpoint position toward the own vehicle. The CPU sets the second viewpoint position such that the entire own vehicle 911 and the separation lines (first separation line 913 and second separation lines 914) separating the perpendicular parking region in which the own vehicle 911 is parked are included in the viewpoint image (front image).

The CPU also displays in the third display region 303 a message 930 for notifying that the parking of the vehicle has been completed, and causes the speaker 85 to utter that message. When a predetermined period of time has elapsed since the start of the screen display of this step, the CPU ends the screen display in the parking assist mode and switches to a screen display in the navigation mode. Even after the predetermined period of time has elapsed, when a switch (not shown) is operated (in the case where the own vehicle has not moved from the position at the time of completion of parking), the CPU may display the second overhead view image 910 in the first display region 301 and display the second viewpoint image 920 in the second display region 302.

Step 650: The CPU sets the value of the request flag FHS and the value of the execution flag FHE to “0”.

As described above, when it is determined that the own vehicle has reached the target position, the apparatus of this embodiment displays in the second display region 302 the second viewpoint image 920, which is an image of the own vehicle and the peripheral region of the own vehicle, based on the second virtual viewpoint different from the first virtual viewpoint. For example, in the case of the second overhead view image 910, because a part of the first separation line 913 is hidden under the front end portion of the own vehicle 911, it may be difficult for the driver to grasp the positional relationship between the front end portion of the own vehicle 911 and the first separation line 913 in the vicinity thereof. In contrast, with the apparatus of this embodiment, the driver can more accurately grasp the positional relationship between the front end portion of the own vehicle 911 and the first separation line 913 in the vicinity of the front end portion by looking at the second viewpoint image 920.

The apparatus of this embodiment displays, at and after the point in time at which the own vehicle is determined to have reached the target position, the second overhead view image 910, which is the above-mentioned image of the own vehicle and the peripheral region of the own vehicle based on the first virtual viewpoint, in the first display region 301. In addition to this, the apparatus of this embodiment displays the second viewpoint image 920, which is an image of the own vehicle and the peripheral region of the own vehicle based on the second virtual viewpoint, in the second display area 302. Therefore, the driver can confirm the final parking state of the own vehicle from a plurality of viewpoint positions. This allows the driver to more accurately grasp the “positional relationship between the own vehicle and a separation line, an object, and the like”.

Regarding the second overhead view image 910, the size of the own vehicle 911 and the size of each of the first separation line 913 and the second separation lines 914 are larger than those of the first overhead view image 810 displayed during execution of the parking assist control. Therefore, visibility exhibited when the “positional relationship between the vehicle and a separation line, an object, and the like” is confirmed is improved.

(Operations in Parallel Parking Assist)

Next, operations to be performed when parking assist control is executed in response to a parallel parking assist request are described. The parallel parking assist control is the same control as the perpendicular parking assist control except that the region (target region) to which the own vehicle is to be finally moved and the viewpoint image displayed on the screen are different. The following description mainly focuses on those differences.

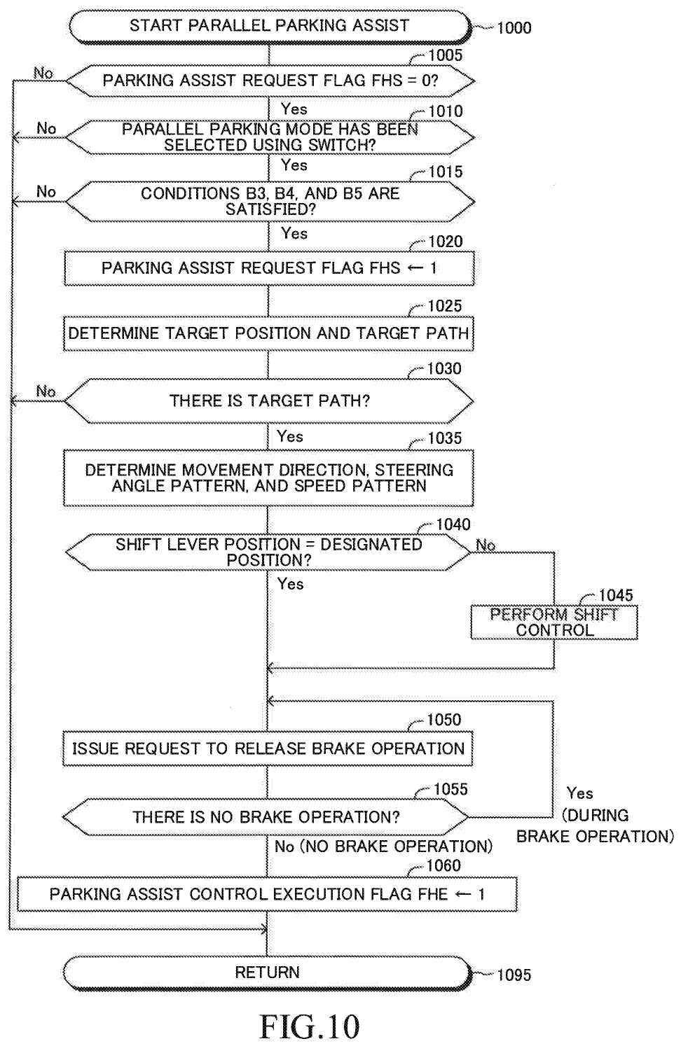

The CPU is configured to execute the routine illustrated in FIG. 10 each time the second predetermined time elapses. When a predetermined timing is reached, the CPU starts the processing from Step 1000 of FIG. 10, and advances the processing to Step 1005. In Step 1005, the CPU determines whether or not the value of the request flag FHS is “0”. Thus, the CPU determines whether or not the above-mentioned condition B1 is satisfied. When the value of the request flag FHS is not “0”, the CPU makes a determination of “No” in Step 1005, advances the processing directly to Step 1095, and temporarily ends this routine.

Assuming that the value of the request flag FHS is “0”, the CPU makes a determination of “Yes” in Step 1005, and advances the processing to Step 1010. In Step 1010, the CPU determines whether or not the parallel parking mode has been selected by a predetermined operation of the parking assist switch 84 (whether or not the condition B2 is satisfied). When it is determined that the parallel parking mode is not selected, the CPU makes a determination of “No” in Step 1010, advances the processing directly to Step 1095, and temporarily ends this routine.

Assuming that the parallel parking mode has been selected, the CPU makes a determination of “Yes” in Step 1010, and advances the processing to Step 1015. In Step 1015, the CPU determines whether or not all of the above-mentioned “condition B3, condition B4, and condition B5” are satisfied. The condition that all of the conditions B3, B4, and B5 are satisfied is also referred to as “parallel parking assist execution condition”. When the parallel parking assist execution condition is not satisfied, the CPU makes a determination of “No” in Step 1015, advances the processing directly to Step 1095, and temporarily ends this routine.

Assuming that the parallel parking assist execution condition is satisfied, the CPU makes a determination of “Yes” in Step 1015, and performs the processing of Step 1020 to Step 1060 in order. The CPU then advances the processing to Step 1095, and temporarily ends this routine. The details of Step 1020 to Step 1060 are the same as the details of Step 420 to Step 460 of the routine of FIG. 4, respectively, and hence a description thereof is omitted here.

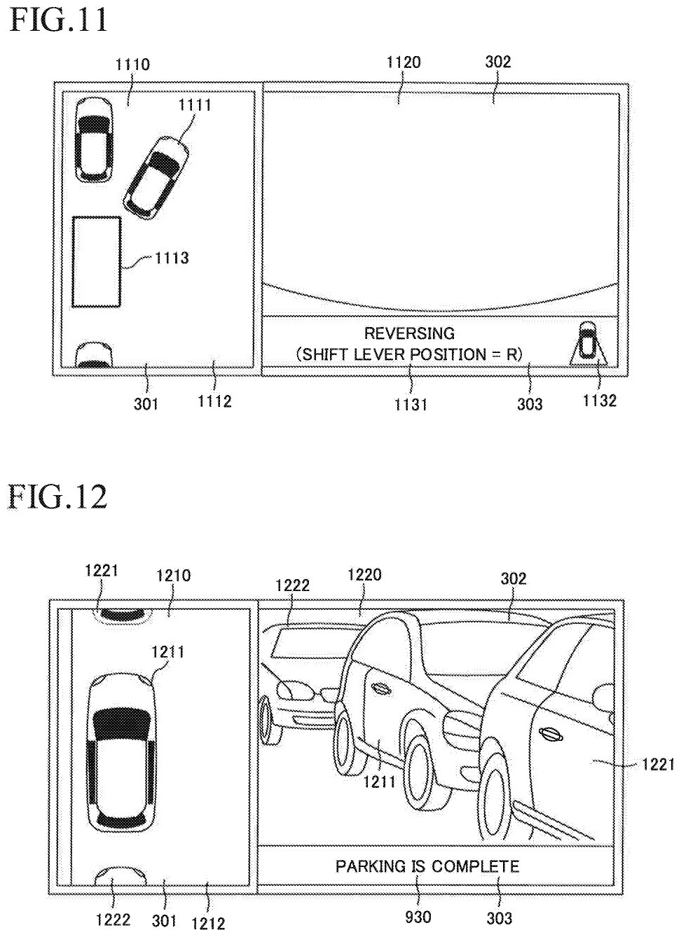

The routine illustrated in FIG. 5 can be applied to the parallel parking assist control. Therefore, when the predetermined timing is reached, the CPU starts the processing from Step 500 of FIG. 5. When the processing by the CPU has advanced to Step 520, as illustrated in FIG. 11, the CPU displays a first overhead view image 1110 in the first display region 301 at the first display magnification and displays a travel direction image 1120 in the second display region 302. The first overhead view image 1110 corresponds to an example of the “first viewpoint image”. The first overhead view image 1110 includes an own vehicle 1111 and a peripheral region 1112 of the own vehicle 1111. The peripheral region 1112 includes an object present in the vicinity of the own vehicle 1111 and at least a part of a target region 1113 corresponding to the target position. The CPU also displays a travel direction message 1131 and a vehicle mark 1132 in the third display region 303.

The routine illustrated in FIG. 6 can be applied to the parallel parking assist control. Therefore, when the predetermined timing is reached, the CPU starts the processing from Step 600 of FIG. 6. When the processing by the CPU has advanced to Step 640, as illustrated in FIG. 12, the CPU displays a third overhead view image 1210 in the first display region 301 and displays a third viewpoint image 1220 in the second display region 302.

In this example, the third overhead view image 1210 is an enlarged image of the first overhead view image 1110 and corresponds to an example of the “first viewpoint image”. The CPU displays the first overhead view image 1110 in the first display region 301 at a third display magnification, which is larger than the first display magnification. For example, when a first another vehicle 1221 is present in front of an own vehicle 1211 and a second another vehicle 1222 is present behind the own vehicle 1211, the CPU sets the third display magnification to a magnification that allows display of the entire own vehicle 1211, a part of the rear end portion of the first another vehicle 1221, and a part of the front end portion of the second another vehicle 1222. Therefore, the third overhead view image 1210 includes the entire own vehicle 1211 and a peripheral region 1212 of the own vehicle 1211. The peripheral region 1212 includes a part of the rear end portion of the first another vehicle 1221 present in front of the own vehicle 1211 and a part of the front end portion of the second another vehicle 1222 present behind the own vehicle 1211.

The third viewpoint image 1220 is a viewpoint image of the own vehicle and the peripheral region of the own vehicle based on a third virtual viewpoint different from the first virtual viewpoint and the second virtual viewpoint described above. The viewpoint position of the third virtual viewpoint is a position on the road on which the own vehicle has traveled along, and is a position (third viewpoint position) separated from the own vehicle by a predetermined third distance in an oblique front direction to the right of the own vehicle. The viewpoint direction of the third virtual viewpoint is the direction from the third viewpoint position toward the own vehicle. The third viewpoint image 1220 may also be referred to as “oblique viewpoint image”. The CPU sets the third viewpoint position such that the right side of the own vehicle 1211, a part of the right side of the first another vehicle 1221, and a part of the right side of the second another vehicle 1222 are included in the viewpoint image (oblique viewpoint image).

As described above, the apparatus of this embodiment displays in the second display region 302 the third viewpoint image 1220, which is an image of the own vehicle and the peripheral region of the own vehicle at the point in time at which it is determined that the own vehicle has reached the target position, and is based on a third virtual viewpoint different from the first virtual viewpoint. In this way, the virtual viewpoint (third virtual viewpoint) set at the point of completion of the parking assist control of parallel parking (point at which the own vehicle reaches target position) is different from the virtual viewpoint (second virtual viewpoint) set at the point of completion of the parking assist control of the perpendicular parking. The driver can confirm the final parking state of the own vehicle at the time when the vehicle is parked through the parallel parking mode from an appropriate virtual viewpoint. The driver can, by looking at the third viewpoint image 1220, more accurately grasp whether the right side of the own vehicle 1211 (side facing the road along which the own vehicle is traveling) does not protrude toward to the road side as compared with the right side of the first another vehicle 1221 and the right side of the second another vehicle 1222.

The driver can also, by looking at the third overhead view image 1210 being an enlarged image of the first overhead view image 1110, more accurately grasp the distance between the own vehicle 1211 and the rear end portion of the first another vehicle 1221 and the distance between the own vehicle 1211 and the front end portion of the second another vehicle 1222.

The present disclosure is not limited to the embodiments described above, and various modification examples can be adopted within the scope of the present disclosure.

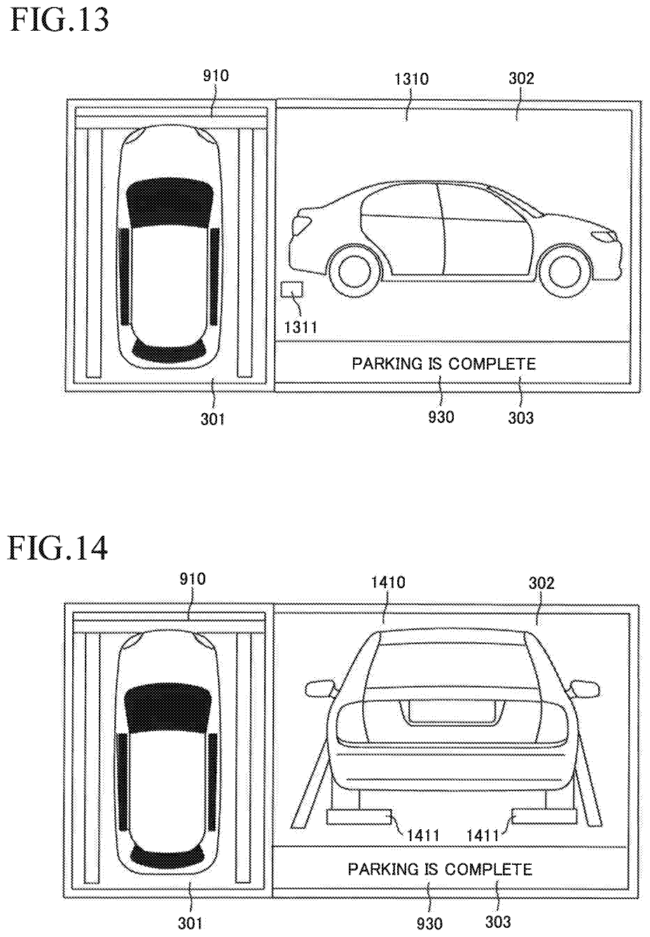

The viewpoint image (second viewpoint image) displayed at and after the point in time at which the own vehicle is determined to have reached the target position is not limited to the example (front image) described above. The second viewpoint image is only required to be an image of the own vehicle and the vicinity of the own vehicle from a position separated from the own vehicle in a direction different from the direction directly above the own vehicle. As illustrated in FIG. 13, the parking assist ECU 10 may display in the second display region 302 a side image 1310 as the second viewpoint image at and after the point in time at which the own vehicle is determined to have reached the target position. The side image 1310 is a viewpoint image of the own vehicle and the peripheral region of the own vehicle based on a fourth virtual viewpoint. The viewpoint position of the fourth virtual viewpoint is a position (fourth viewpoint position) separated from the center position in a vehicle longitudinal direction on the right side of the vehicle body by a predetermined fourth distance in the right direction. The viewing direction of the fourth virtual viewpoint is the direction from the fourth viewpoint position toward the own vehicle. As described above, when parking of the own vehicle is complete, a part of the wheel stop may be hidden under the own vehicle. In the case of the overhead view image (second overhead view image 910), the driver cannot accurately confirm the position of a wheel stop 1311. With this configuration, the driver can accurately grasp the distance between the rear wheels and the wheel stop 1311 by looking at the side image 1310. As another example, when there is an obstacle (e.g., fence and wall) present behind the own vehicle, the driver can accurately grasp the distance between the own vehicle and the obstacle by looking at the side image 1310.

As illustrated in FIG. 14, the parking assist ECU 10 may also display in the second display region 302 a rear image 1410 as the second viewpoint image at and after the point in time at which the own vehicle is determined to have reached the target position. The rear image 1410 is a viewpoint image of the own vehicle and the peripheral region of the own vehicle based on a fifth virtual viewpoint. The viewpoint position of the fifth virtual viewpoint is a position (fifth viewpoint position) separated from the center position in the vehicle width direction of the rear end portion of the vehicle body by a predetermined fifth distance toward the rear of the own vehicle. The viewing direction of the fifth virtual viewpoint is the direction from the fifth viewpoint position toward the own vehicle. With this configuration, the driver can accurately grasp the positional relationship between the rear wheels and the wheel stop 1411 by looking at the rear image 1410.

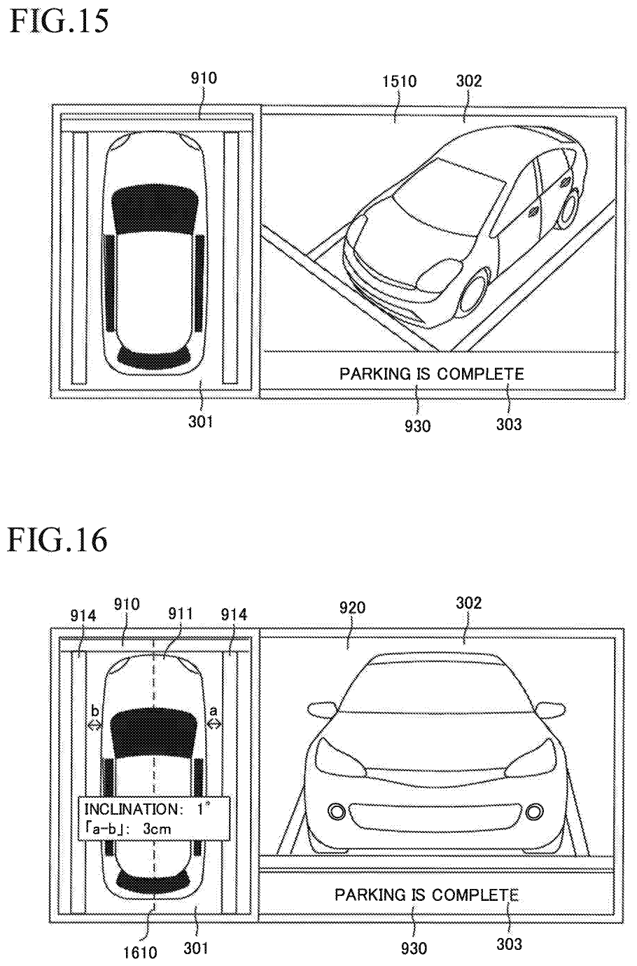

As illustrated in FIG. 15, the parking assist ECU 10 may also display in the second display region 302 an oblique overhead view image 1510 as the second viewpoint image at and after the point in time at which the own vehicle is determined to have reached the target position. The oblique overhead view image 1510 is a viewpoint image of the own vehicle and the peripheral region of the own vehicle based on a sixth virtual viewpoint. The viewpoint position of the sixth virtual viewpoint is the position (sixth viewpoint position) separated from the center position in plan view of the vehicle body of the own vehicle by a predetermined sixth distance in an oblique upward direction. The viewing direction of the sixth virtual viewpoint is the direction from the sixth viewpoint position toward the own vehicle.

The parking assist ECU 10 may set a plurality of viewpoint positions separated from the own vehicle in a plurality of directions different from the direction directly above the own vehicle at the point in time at which the own vehicle is determined to have reached the target region. The parking assist ECU 10 may also generate a plurality of viewpoint images of the own vehicle and the vicinity of the own vehicle as viewed from the plurality of viewpoint positions, and serially display the plurality of viewpoint images in the second display region 302. For example, at and after the point in time at which the own vehicle is determined to have reached the target position, the parking assist ECU 10 may serially display two or more images among the above-mentioned “front image, side image, rear image, and oblique overhead view image” in the second display region 302.

The parking assist ECU 10 may also generate a viewpoint image while rotating the position of the virtual viewpoint about the own vehicle by 360 degrees in plan view, and display the generated viewpoint image in the second display region 302. This enables the driver to confirm the final parking state of the own vehicle with a smooth moving image having continuity. For example, the parking assist ECU 10 generates a viewpoint image each time the position of the virtual viewpoint is rotated by a predetermined angle about the own vehicle from the second viewpoint position at and after the point in time at which the own vehicle is determined to have reached the target region, and displays the generated viewpoint image in the second display region 302. The driver can confirm the final parking state of the own vehicle while rotating the position of the viewpoint by 360 degrees.

As illustrated in FIG. 16, the parking assist ECU 10 may display on the screen the following numerical values 1 and 2 representing the positional relationship between the own vehicle and a separation line at the point in time at which the own vehicle is determined to have reached the target position.
(Numerical value 1) Inclination of a “longitudinal direction axis 1610 passing through the center of the own vehicle in the vehicle width direction” with respect to the second separation line 914
(Numerical value 2) Difference between a distance “a” from the right side of the own vehicle 911 to the second separation line 914 on the right side and a distance “b” from the left side of the own vehicle 911 to the second separation line 914 on the left side

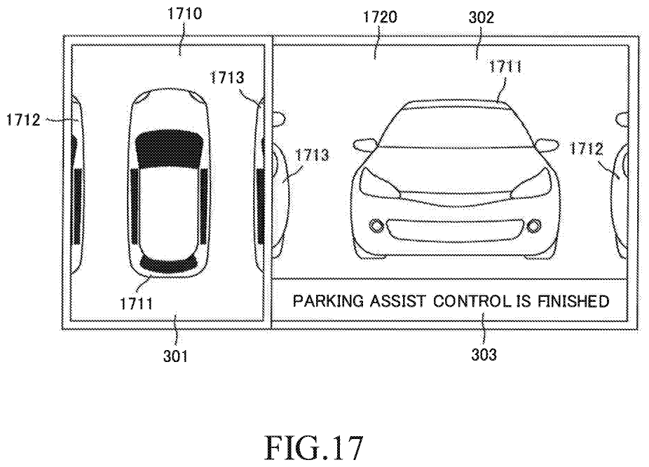

When there is no separation line separating the perpendicular parking region, and the own vehicle is to be parked in a space between two another vehicles (first another vehicle and second another vehicle), as illustrated in FIG. 17, the parking assist ECU 10 may generate a second overhead view image 1710 and a second viewpoint image 1720. The parking assist ECU 10 sets the second display magnification to a magnification that allows display of an entire own vehicle 1711, a part of the right side of a first another vehicle 1712, and a part of the left side of a second another vehicle 1713. The CPU sets the second viewpoint position such that the viewpoint image (front image) includes the entire own vehicle 1711, the part of the right side of the first another vehicle 1712, and the part of the left side of the second other vehicle 1713. With this configuration, the driver can more accurately grasp the positional relationship between the own vehicle 1711, and the first another vehicle 1712 and second other vehicle 1713 at and after the point at which the parking assist control for the perpendicular parking is complete.

The viewpoint image displayed at and after the point at which the parking assist control for parallel parking is complete (at and after the point at which the own vehicle is determined to have reached the target position) is not limited to the example described above (oblique viewpoint image). The parking assist ECU 10 may display in the second display region 302 one or more images among the above-mentioned “front image, side image, rear image, and oblique overhead view image” in place of, or in addition to, the third viewpoint image (oblique viewpoint image) 1220 at and after the point at which the own vehicle is determined to have reached the target position. As described above, at and after the point at which the own vehicle is determined to have reached the target position, the parking assist ECU 10 may also generate a viewpoint image while rotating the position of the virtual viewpoint by 360 degrees in plan view about the own vehicle, and display the generated viewpoint image in the second display region 302.

The parking assist ECU 10 may display, at and after the point at which the own vehicle is determined to have reached the target position, the first overhead view image in the first display region 301 at the display magnification (i.e., first display magnification) used during execution of the parking assist control.

The CPU may calculate, when the own vehicle cannot be moved to the provisional target position merely by moving the own vehicle in reverse only once, as the provisional target path, a path in which the own vehicle is moved forward and then in reverse, or is moved in reverse, then forward, and then again moved in reverse (i.e., route involving switching of the travel direction of the own vehicle). For example, the CPU calculates a first path for moving the own vehicle forward to a travel direction switching position (i.e., position at which the own vehicle is to temporarily stop in order to switch the position of the shift lever from the drive position (D) to the reverse position (R)) from the current position, and a second path for moving the own vehicle in reverse from the travel direction switching position to the target position, and sets the first path and the second path as the provisional target path. In this configuration, when the own vehicle moves to the travel direction switching position during the parking assist control (parking assist control for perpendicular parking or parking assist control for parallel parking), the CPU transmits a braking force control command to the brake ECU 30 to generate a braking force and cause the own vehicle to stop. The CPU also transmits a shift control command to the SBW ECU 60 to change the position of the shift lever to the position specified by the shift control command.

The parking assist switch 84 is only required to be a switch to be operated when the driver requests parking assist to generate a signal representing the request. The parking assist switch may be a device configured to recognize a request for parking assist by the driver by using a voice recognition device. Such a device is equivalent to a switch to be operated by voice, and may serve as an operation switch (operating device) in one embodiment. The parking assist ECU may include a request monitoring function for determining whether or not a parking assist request has been issued from a switch operation by the driver and/or the voice of the driver.

Images relating to parking assist (above-mentioned viewpoint image and travel direction image) may be displayed on the display 51 in place of, or in addition to, the touch panel 73. The meter ECU 50 may display an image relating to parking assist in accordance with a display command transmitted from the parking assist ECU 10. The display 51 may include a display dedicated to parking assist.

The parking assist ECU 10 may also be configured to be able to further execute “forward perpendicular parking assist control”, in which parking assist is performed when the own vehicle is moved forward such that the longitudinal direction of the own vehicle and the longitudinal direction of another vehicle are parallel to each other. In this case, each time the parking assist switch 84 is pressed, the switch mode is switched among, in order, the reverse perpendicular parking mode, the forward perpendicular parking mode, the parallel parking mode, and the unset mode.

The parking assist ECU 10 may be configured to execute only steering angle automatic control as the parking assist control. In this case, when the final target position and the target path are determined, the parking assist ECU 10 displays guidance relating to parking assist (shift lever position) on the touch panel 73. The driver changes the position of the shift lever in accordance with the guidance relating to the parking assist. When the driver has changed the position of the shift lever to the guided position, the parking assist ECU 10 starts the steering angle automatic control. The driver moves the own vehicle by operating the brake pedal and the accelerator pedal. When the own vehicle reaches the target position, the parking assist ECU 10 displays on the screen a message notifying the driver that the vehicle is to be stopped, and causes the speaker 85 to utter that message. When the driver operates the brake pedal to stop the own vehicle, the parking assist ECU 10 ends the parking assist control (steering angle automatic control) (i.e., parking assist control is complete). Then, the parking assist ECU 10 displays the second overhead view image (or the third overhead view image) in the first display region 301 and displays the second viewpoint image (or the third viewpoint image) in the second display region 302.

What is claimed is:

1. A parking assist apparatus, comprising:
an information acquisition device including at least an image pickup device configured to acquire image data of surroundings of a vehicle, the information acquisition device being configured to acquire vehicle-surroundings information including information on an object present in the surroundings of the vehicle and information on a separation line on a road surface in the surroundings of the vehicle;
a path determination module programmed to determine, based on the vehicle-surroundings information, a target region, which is a region in which the vehicle is to occupy when parking of the vehicle is complete, and determine, as a target path, a path along which the vehicle is movable from a position of the vehicle at a current point in time to the target region;
a parking assist module programmed to execute parking assist control including steering angle automatic control on the vehicle for moving the vehicle along the determined target path; and
a display device configured to display an image to an occupant of the vehicle,
the parking assist module being programmed to display on the display device an image generated based on the image data acquired by the image pickup device, the image being an image of the vehicle and a vicinity of the vehicle as viewed from a position separated from the vehicle in a direction different from a direction directly above the vehicle at a point in time at which the vehicle is determined to have reached the target region.

2. The parking assist apparatus according to claim 1,
wherein the display device is configured to display an image including a first display region and a second display region, and
wherein the parking assist module is programmed to:
generate, based on the image data acquired by the image pickup device, a first viewpoint image of the vehicle and a vicinity of the vehicle as viewed from a position separated from the vehicle in a direction directly above the vehicle at a point in time at which the vehicle is determined to have reached the target region, and a second viewpoint image of the vehicle and a vicinity of the vehicle as viewed from a position separated from the vehicle in a direction different from the direction directly above the vehicle at the point in time at which the vehicle is determined to have reached the target region; and
display the first viewpoint image in the first display region and display the second viewpoint image in the second display region.

3. The parking assist apparatus according to claim 2, wherein the parking assist module is programmed to:
generate the first viewpoint image during a period from a point in time at which the parking assist control starts to before the vehicle reaches the target region, and display the first viewpoint image in the first display region at a first display magnification, which allows the entire vehicle and at least a part of the target region to be displayed; and
display, at and after a point in time at which the vehicle is determined to have reached the target region, the first viewpoint image in the first display region at a second display magnification, which allows the entire vehicle and at least a part of a peripheral region of the vehicle to be displayed, and which is larger than the first display magnification.

4. The parking assist apparatus according to claim 1, wherein the parking assist module is programmed to:
set a plurality of viewpoint positions separated from the vehicle in a plurality of directions different from the direction directly above the vehicle at a point in time at which the vehicle is determined to have reached the target region;
generate a plurality of images of the vehicle and a vicinity of the vehicle as viewed from the plurality of viewpoint positions based on the image data acquired by the image pickup device; and
serially display the plurality of images on the display device.
